(19) United States
(12) Patent Application Publication
(10) Pub. No.: US 2004/0069812 A1
(43) Pub. Date: Apr. 15, 2004

(54) Fluid dispenser

(75) Inventors: Stephane Beranger, Le Neubourg (FR); Firmin Garcia, Evreux (FR); Philippe Levillain, Evreux (FR); Franck Plessis, Le Neubourg (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S.

(21) Appl. No.: 10/677,342

(22) Filed: Oct. 3, 2003

Related U.S. Application Data
(60) Provisional application No. 60/429,542, filed on Nov. 29, 2002.

(30) Foreign Application Priority Data
Oct. 7, 2002 (FR) FR-02.12415

(51) Int. Cl. G01F 11/06

(52) U.S. Cl. 222/321.9

(57) ABSTRACT

A fluid dispenser comprising:

a fluid reservoir (1; 1′) provided with an opening (10; 10′), the opening being formed by a neck (10) having a top end (12) and an inside wall defining a narrow aperture segment (111) in the vicinity of the top end, and a recessed segment (112) which extends below the narrow aperture segment;

a dispensing member (2) provided with a body (20); and

a fixing member (3; 3′) for fixing said body in the opening;

said fixing member being provided with a skirt (31; 31′) serving to come into engagement in the opening, and with a sleeve (32) serving to come into engagement around the body;

said fluid dispenser being characterized in that the body forms a cam segment (204) for deforming the skirt outwards into pressed contact with the opening, the skirt (31) having a sealing zone (313) which, in the final position, comes into leaktight contact with the narrow aperture segment (111), and a fixing zone (314) which, in the final position, comes into tight-fitting contact with the recessed segment (112).

### CROSS REFERENCE TO RELATED APPLICATION

This application claims the benefit under 35 U.S.C. §119(e) of pending U.S. provisional patent application Serial No. 60/429,542, filed Nov. 29, 2002, and priority under 35 U.S.C. §119(a)-(d) of French patent application No. FR-02.12415, filed Oct. 7, 2002.

### BACKGROUND OF THE INVENTION

The present invention relates to a fluid dispenser comprising a fluid reservoir provided with an opening, a dispensing member provided with a body, and a fixing member for fixing said body in the opening. This type of dispenser is in frequent use in the fields of perfumes, cosmetics, or indeed pharmaceuticals, for dispensing fluids such as perfumes, lotions, creams, gels, and pharmaceutical substances in liquid or even in powder form.

Various techniques exist for fixing a dispensing member in the opening of a reservoir. Therefore, various types of fixing member exist that co-operate either with the inside of the opening or with the outside of the opening. For example, crimp-on rings or screw-on rings have long been known. Those two techniques make it possible to fix the dispensing member to the outside of the opening. Fixing members using snap-fastening or locking onto the outside of the opening are also known. A well-known configuration implements a ring forming an external skirt provided internally with fastening heads or with a continuous fastening bead. The skirt can be continuous or split to form tabs separated by slots. In addition, the opening is in the form of a neck defining an outside wall provided with a reinforcement defined at its bottom by an inwardly extending shoulder. The fastening heads or the fastening bead serve(s) to come into engagement with the inwardly-extending shoulder and the skirt is then locked in position by a trim band that surrounds the skirt. A variant even makes provision to use the bottom edge of the trim band to deform the bottom portion of the skirt by material creep so as to deform it inwards under the reinforced portion of the neck.

Yet other types of fixing member exist that make it possible to fix the dispensing member to the inside of the opening. For example, mention may be made of a very simple technique consisting in engaging the fixing member by force or even in engaging the dispensing member directly by force into the opening in the manner of a stopper. More elaborate techniques provide one or more recesses in the inside wall of the opening that serve to receive projecting portions of the fixing member. Internal snap-fastening is then performed. With such a technique, it is necessary to push relatively strongly on the fixing member or even sometimes on the dispensing member in order to drive the fixing member into the opening. In addition, driving or force-fitting the fixing member into the opening increases in the pressure inside the reservoir, which may be problematic when the reservoir has a very small capacity.

### BRIEF SUMMARY OF THE INVENTION

An object of the invention is to remedy the above-mentioned drawbacks of the prior art by defining a fixing member for fixing to the inside of the opening that requires almost no thrust force to be exerted on the fixing member and that does not increase in the pressure inside the reservoir. In addition, fixing is very secure.

To achieve these objects, the present invention provides a fluid dispenser comprising a fluid reservoir provided with an opening, the opening being formed by a neck having a top end and an inside wall defining a narrow aperture segment in the vicinity of the top end, and a recessed segment which extends below the narrow aperture segment, a dispensing member provided with a body and a fixing member for fixing said body in the opening, said fixing member being provided with a skirt serving to come into engagement in the opening, and with a sleeve serving to come into engagement around the body, said fluid dispenser being characterized in that the body forms a cam segment for deforming the skirt outwards into pressed contact with the opening, the skirt having a sealing zone which, in the final position, comes into leaktight contact with the narrow aperture segment, and a fixing zone which, in the final position, comes into tight-fitting contact with the recessed segment. Thus, the fixing body serves as a tool for bringing the skirt into the final assembled position. It should be noted that the skirt co-operates with the opening where it is in pressed contact, and it preferably does not extend below the opening into the reservoir. When the opening is formed by a neck defining an inside wall, the skirt co-operates with said inside wall and does not extend below the neck where the neck is connected to the body of the reservoir.

Advantageously, the body has a large-diameter segment on which the sleeve comes into leaktight engagement in the final assembled position.

Advantageously, the body has an intermediate segment situated above the cam segment and below the large-diameter segment, the skirt coming into tight-fitting engagement with said intermediate segment in the final assembled position, the sleeve being in engagement with said intermediate segment before the skirt comes into engagement with the cam segment.

Advantageously, the body has a small-diameter segment situated below the cam segment, the skirt being in engagement with the small-diameter segment when the sleeve is in engagement with the intermediate segment. Thus, the sleeve is initially engaged and held temporarily in position at the intermediate segment of the body, and it is then moved along the body so as to engage over the large-diameter segment, with which it defines leaktight tight-fitting engagement corresponding to the final assembled position. In addition, the skirt is initially engaged over the body at the small-diameter segment, and it is then moved along the body by going over the cam segment to reach the final assembled position in engagement with the intermediate segment. Naturally, it can be imagined that the cam segment and the intermediate segment may form a single shaped-section segment, e.g. shaped frustoconically.

In a variant, the opening has a substantially cylindrical inside wall. In which case, the portion of the skirt that comes into pressed contact with the cylindrical inside wall of the opening performs both sealing and fixing.

In an embodiment, the skirt forms tabs separated by slots. In which case, the tabs formed by the skirt guarantee fixing only, sealing being provided by the top portion of the skirt which is not split but which is nevertheless deformed against the inside wall of the opening.

In another aspect of the invention, the body forms a top collar under which the sleeve comes into abutment in the final position.

According to another characteristic of the invention, the sleeve has an inside wall that forms a holding bead adapted to come into tight-fitting engagement with the intermediate segment to hold the fixing member in place on the body when it is inserted into the neck, before it reaches its final assembled position.

In addition, the skirt may have an inside wall provided with a cam bead serving to come into engagement with the cam segment.

In another aspect, the skirt is provided with a bottom lip in contact with the body. In which case, the skirt may be in contact with the intermediate segment via the cam bead and via the bottom lip only.

According to another characteristic, the fixing member is provided with an abutment flange serving to come freely into contact with the opening without being force-fitted. Thus, the dispensing member may be pre-engaged into the fixing member with the sleeve situated at the intermediate segment and the skirt at the small-diameter segment. This sub-assembly is then easy to insert into the opening without leaktight contact or friction until the abutment flange comes into abutment on the opening. Thus, no increase in pressure in generated inside the reservoir.

### BRIEF DESCRIPTION OF THE DRAWINGS

The invention is described more fully below with reference to the accompanying drawings which show two embodiments of the of the invention by way of non-limiting example.

In the figures:

FIGS. 1 to 3 show three successive steps in assembling a first embodiment of a dispenser of the invention;

FIG. 4 is an enlarged view of a detail of FIG. 3; and

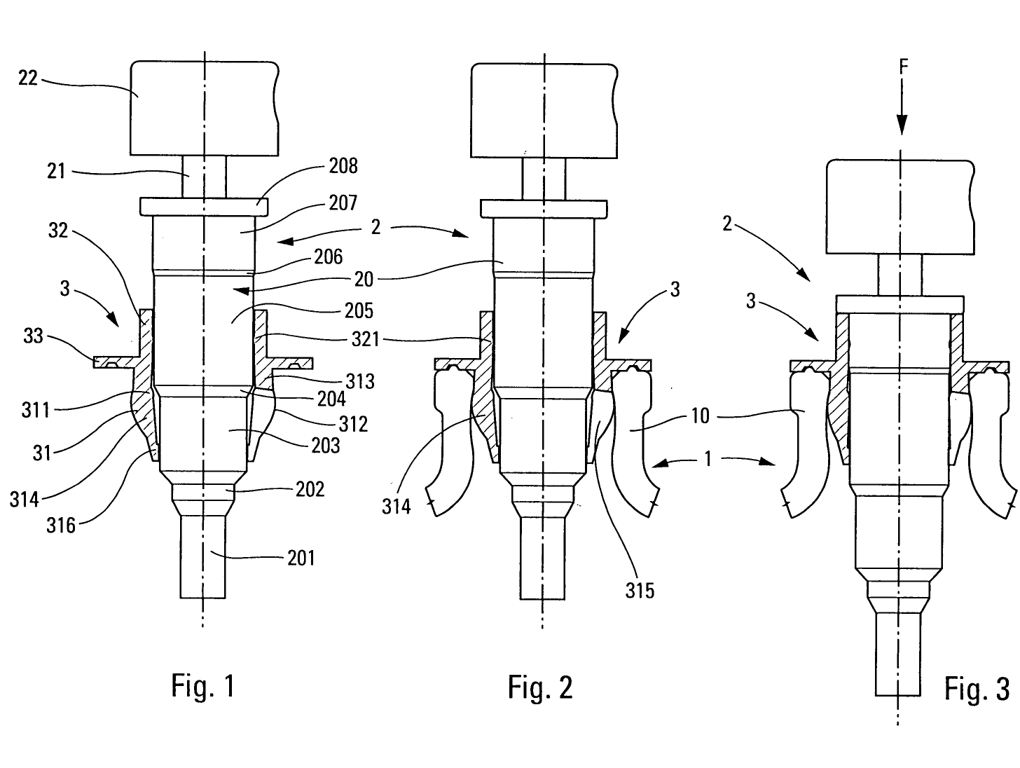

FIGS. 1 to 7 are views similar to FIGS. 1 to 3 for a second embodiment of the invention.

### DETAILED DESCRIPTION OF THE INVENTION

Reference is made firstly to FIGS. 1 to 4 to explain the first embodiment of the invention. The dispenser shown in fragmentary manner is made up of three component elements, namely a reservoir 1 forming a neck 10 which defines an opening that communicates with the inside of the reservoir, a dispenser member 2 which may be a pump or a valve, and a fixing member 3 making it possible to fix the dispensing member 2 to the neck 10.

In the first embodiment, the reservoir 1 may typically be a reservoir made of glass and used as a bottle, in particular in the field of perfumes. The neck 10 of the reservoir has an annular top end wall 12 which may advantageously be provided with a sealing profile 122. The neck 10 further has an inside wall 11 which is connected to the end wall 12 via an inlet bevel 121. Below the inlet bevel 121, the inside wall 11 forms a narrow aperture segment 111 which may advantageously be cylindrical. Below the narrow aperture segment 111, the inside wall 11 forms a recessed segment 112 whose inside diameter is larger than the inside diameter of the narrow aperture segment 111. Below the recessed segment 112, the inside wall 111 forms a rounded segment 113 which connects to the inside wall of the shoulder that makes it possible to connect the neck 10 to the body of the reservoir (not shown). The inner diameter of segment 113 is smaller than that the segment 112, and advantageously also smaller than that of segment 111. This is an entirely conventional design for a neck of a reservoir made of blown glass.

The dispensing member 2 comprises a body 20 inside which an actuating rod 21 can be moved by pressing on a pusher 22 mounted at the top end of the rod 21. At its bottom end, the body 20 defines an inlet sleeve 201 which defines an inlet making it possible to put the inside of the reservoir into communication with the inside of the body 20. Above the sleeve 201, the body forms a transition segment 202 which flares outwards frustoconically and/or cylindrically. Above the transition segment 202, the body forms a small-diameter cylindrical segment 203. The segment 203 connects upwards to a cam segment 204 which, in this example, is frustoconical by flaring outwards and upwards. Beyond the cam segment 204, the body forms a cylindrical intermediate segment 205. Above the segment 205, the body forms a junction segment 206 which, in this example, flares frustoconically outwards and upwards. Above the junction segment 206, the body forms a large-diameter segment 207 which is advantageously cylindrical in shape. Finally, above the large-diameter segment 207, the body forms a top collar 208 which projects outwards. To sum up, the body 20 forms three cylindrical main segments 203, 205, and 207 having increasing diameters and connected together via a junction segment 206 or via a cam segment 204.

In this example, the fixing member 3 is in the form of a ring provided with a skirt 31 at its bottom, with a sleeve 32 at its top portion, and with an abutment flange 33 which extends radially outwards where the sleeve 32 connects to the skirt 31.

The skirt 31 may be fully continuous, but preferably it is split at least over a portion of its height so as to define an uninterrupted top margin 313 from which tabs 314 extend that are separated by slots 315 as shown in FIGS. 1, 2, or 3. Where it forms the tabs 314, the skirt defines an outside wall forming an outer bulge 312. The diameter of the skirt at the bulge 312 is larger than the diameter of the skirt at the continuous top margin 313. Below the bulge 312, the skirt tapers substantially frustoconically. Also at the tabs 314, the skirt 31 defines an inside wall forming a lip 316 at its bottom end. In addition, the inside wall of the skirt 31 forms a bead 311 which may, for example, be in the form of a series of protuberances formed on respective ones of the tabs 314 and disposed along a circular line. The same applies for the lip 316 which may also be in the form of a series of reinforcements disposed at the bottom ends of the tabs 314. Naturally, it is also possible to use a continuous skirt with a continuous lip 316 and a continuous bead 311. The bead 311 has a cam function as is described below.

The sleeve 32 has a free annular top end 322 and an inside wall that defines a holding bead 321.

In addition, the abutment flange 33 advantageously forms an annular recess 331 serving to receive the sealing profile 122 formed by the top end wall 12 of the neck 10.

Reference is made below to FIG. 1 to explain how the fixing ring 3 is initially engaged over the body 20 prior to fitting the ring into the neck 10. The sleeve 32 is engaged on the intermediate segment 205 of the body 20. The holding bead 321 is in tight-fitting engagement with the intermediate segment 205. Therefore, the inside diameter of the bead 321 is slightly smaller than the outside diameter of the segment 205, while the remainder of the inside wall of the sleeve 32 may have an inside diameter slightly larger than the outside diameter of the segment 205. Thus, the sleeve 32 is in contact with the segment 205 at the holding bead 321 only. The skirt 31 which starts below the abutment flange 33 extends partially at the intermediate segment 205, but also at the cam segment 204 and at the small-diameter segment 203. It can be seen in FIG. 1 that the tabs 314 formed by the skirt extend fully at the cam segment 204 and at the small-diameter segment 203. The cam bead 311 is situated at the cam segment 204 without coming into contact therewith. The bottom lip 313 comes into advantageously non-tightly-fitting contact with the small-diameter segment 203. Only the continuous top margin 313 is situated at the intermediate segment 205, without coming into contact with the segment 205. The inside wall of the top margin 313 extends in alignment with the inside wall of the sleeve 32 which is in contact with the intermediate segment 205 only at the holding bead 321. It is in this initial pre-assembly position that the fixing ring 3 is engaged over the body 20 of the dispensing member.

The dispensing member 2 with its fixing ring thus forms a temporary single unit that is engaged into the neck 10 so as to cause the skirt 31 to penetrate into the neck 10 until the abutment flange 33 comes to rest on the top end 12 of the neck. Preferably, the maximum outside diameter of the skirt 31, situated at the outer bulge 312, is equal to or slightly smaller than the minimum inside diameter of the neck situated at the narrow aperture segment 111. As a result, the skirt 31 can be engaged into the neck 10 without excessive friction and without excessive force. However, it can also be imagined that the bulge 312 of the skirt 31 has an outside diameter that is very slightly larger than the inside diameter of the narrow aperture segment so that the skirt can be engaged with very small pressure into the neck 10. In any event, the force necessary for engaging the skirt into the neck must not be larger than the holding force exerted by the holding bead 321 at the intermediate segment 205. It is necessary for the fixing member 3 to maintain its initial position as shown in FIG. 1 until the skirt 31 is engaged in the neck 10 with the abutment flange 33 in abutment on the neck 10. This is shown in FIG. 2.

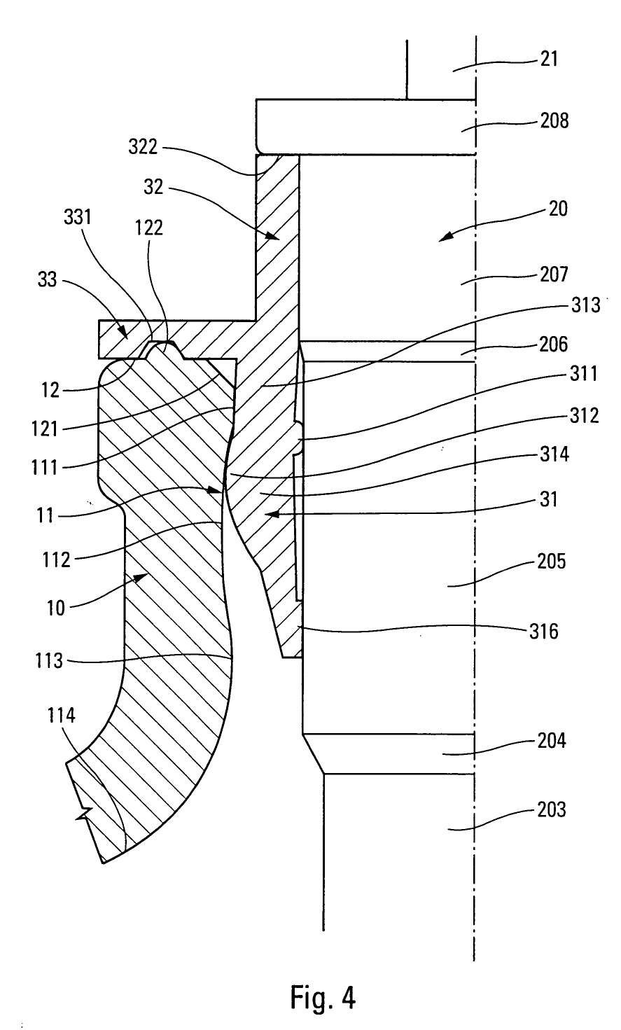

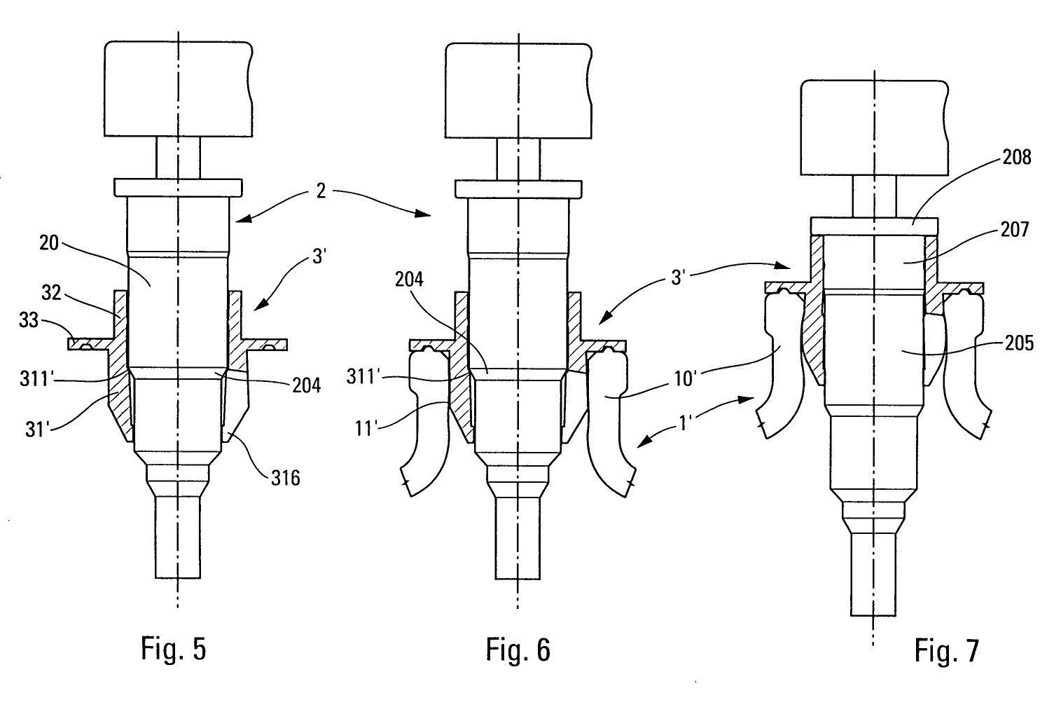

The third assembly step consists in exerting a thrust force F on the dispensing member, i.e. on its pusher or on the collar 208. As soon as the force becomes larger than the holding force exerted by the bead 321, the pump body 20 moves inside the fixing ring 3. In a first stage, the cam bead 311 comes into contact with the cam surface 204 of the body 20. This deforms or expands the skirt outwards so that it comes into pressed contact against the inside wall of the neck 10. Naturally, the cam action performed by the surface 204 causes the outside diameter of the skirt 31 to expand. Given that the cam bead 311 is situated substantially where the tabs 314 connect to the top margin 313, both the top margin 313 and the tabs 314 are subjected to deformation by expansion. It should be noted that the bottom lip 316 is still situated at the small-diameter segment 203. By continuing to exert the thrust force F on the dispensing member, its body 20 continuous to move inside the fixing ring 3. The sleeve 32 then starts to engage with tight-fitting leaktight contact on the large-diameter segment of the body 20. It is therefore preferable for the inside diameter of the sleeve 32 to be slightly smaller than the outside diameter of the large-diameter segment 207. At the same time as the sleeve 32 is continuing to engage over the large-diameter segment 207, the lip 316 initially situated at the small-diameter segment 203 moves over the cam segment 204 to reach the intermediate segment 205. The lip 316 going from the small-diameter segment 203 to the intermediate segment 205 also generates deformation of the skirt by expansion, thereby further increasing the outside diameter of the skirt, particularly at its bulge 312. The final position is reached when the top end 322 of the sleeve 32 comes into abutment under the collar 208, as shown in FIG. 3 and in FIG. 4.

It can be observed that only the sleeve 32 is engaged at the large-diameter segment 207 while forming cylindrical sealing. The skirt 31 is entirely situated at the intermediate segment 205. It can also be observed that the inside wall of the skirt 31 is in contact with the segment 205 at the cam bead 311 and at the bottom lip 316 only. Everywhere else, a gap remains between the skirt and the intermediate segment 205. By means of the cam bead 311 and of the bottom lip 316, the skirt expands outwards to come into leaktight and tight-fitting contact with the inside wall 11 of the neck in two stages, namely an initial stage during which the cam bead 311 comes into engagement with the cam segment 204 so as finally to reach the level of the intermediate segment 205, and a second stage during which the lip 316 follows the same path. The cam bead 311 thus causes the skirt to expand mainly at its top margin 313 and at the top ends of its tabs 314, while the lip 316 mainly causes the bottom ends of the tabs to expand. It can easily be understood that the bulge 312 that is situated between the bead 311 and the lip 316 is subjected to expansion in two successive stages generated by the cam bead 311 and then the lip 316 rising over the cam segment 204 to reach the intermediate segment 205. In addition, since the top margin 313 is continuous and comes into tight-fitting contact with the narrow aperture segment 111, said margin defines an annular or cylindrical sealing zone. The expanded tabs 314 can perform only a holding and locking function.

Reference is made below to FIGS. 5 to 7 which show a variant embodiment in which the dispensing member 2 may be strictly identical to the dispensing member of FIGS. 1 to 4. The body 20 may be staggered in the same way, or at least provided with a small-diameter segment, a cam segment, an intermediate segment, and then a large-diameter segment.

In this example, the reservoir 1′ has a neck 10′ having an inside wall 11 which is substantially cylindrical over its entire height. The top end wall of the neck 10′ may be identical to the top end wall of the preceding embodiment. There is therefore no recessed portion at the inside wall 11′ of the neck 10′ The fixing member 3′ may have a top sleeve 32 and an abutment flange 33 that are strictly identical to the top sleeve and the abutment flange of the preceding embodiment. Conversely, the skirt 31′ differs from the skirt of the preceding embodiment in that it has an outside wall that is substantially cylindrical and an inside wall that forms a top cam shoulder 311′ situated just below the cam segment 204 in the initial pre-assembly position. This can be seen in FIGS. 5 and 6. The cam shoulder 311′ acts in the same way as the cam bead 311 of the preceding embodiment. The skirt 31′ may be engaged inside the neck 10′ without exerting considerable force. For example, the outside diameter of the skirt 31′ is slightly smaller than the inside diameter of the inside wall 11′ of the neck 10′. Thus, the skirt 31′ can be inserted into the neck 10′ until the abutment flange 33 comes into abutment on the top end of the neck 10′. This is shown in FIG. 6. The cam shoulder 311′ is then always situated below the cam segment 204. When pressure is exerted on the dispensing member 2, the cam shoulder 311′ comes into engagement with the cam segment 204 and then rises onto the intermediate segment 205. This causes the skirt 31′ to expand, thereby generating leaktight tight-fitting contact with the inside wall 11″. By continuing to push the dispensing member 2 into the fixing member 3′, it is possible to cause the sleeve 32 to rise over the large-diameter segment 207 as in the preceding embodiment until it comes into abutment via its top end under the collar 208 of the body 20. Since the skirt 31′ is also provided with a bottom lip 316, said lip also rises over the cam segment 204 to reach the intermediate segment 205. The lip 316 rising also generates expansion which improves or supplements the leaktight tight-fitting engagement of the skirt 31′ against the wall 11′.

In this embodiment, the fixing and sealing of the fixing member 3′ is achieved merely by leaktight tight-fitting cylinder-on-cylinder contact. In the preceding embodiment, the recessed portion 112 formed by the inside wall 11 of the neck 10 also performs fastening or locking below the narrow aperture segment 111. This is facilitated by the presence of the peripheral bulge 312.

1/ A fluid dispenser comprising:
a fluid reservoir (1; 1′) provided with an opening (10; 10′), the opening being formed by a neck (10) having a top end (12) and an inside wall defining a narrow aperture segment (111) in the vicinity of the top end, and a recessed segment (112) which extends below the narrow aperture segment;
a dispensing member (2) provided with a body (20); and
a fixing member (3; 3′) for fixing said body in the opening;
said fixing member being provided with a skirt (31; 31′) serving to come into engagement in the opening, and with a sleeve (32) serving to come into engagement around the body;
said fluid dispenser being characterized in that the body forms a cam segment (204) for deforming the skirt outwards into pressed contact with the opening, the skirt (31) having a sealing zone (313) which, in the final position, comes into leaktight contact with the narrow aperture segment (111), and a fixing zone (314) which, in the final position, comes into tight-fitting contact with the recessed segment (112).

2/ A fluid dispenser according to claim 1, in which the body (20) has a large-diameter segment (207) on which the sleeve (32) comes into leaktight engagement in the final assembled position.

3/ A fluid dispenser according to claim 1, in which the body (20) has an intermediate segment (205) situated above the cam segment (204) and below the large-diameter segment (207), the skirt (31; 31′) coming into tight-fitting engagement with said intermediate segment (205) in the final assembled position, the sleeve (32) being in engagement with said intermediate segment (205) before the skirt comes into engagement with the cam segment (204).

4/ A fluid dispenser according to claim 3, in which the body (20) has a small-diameter segment (203) situated below the cam segment (204), the skirt (31; 31′) being in engagement with the small-diameter segment (203) when the sleeve (32) is in engagement with the intermediate segment (205).

5/ A fluid dispenser according to claim 1, in which the opening has a substantially cylindrical inside wall.

6/ A fluid dispenser according to claim 1, in which the skirt forms tabs (314) separated by slots (315).

7/ A fluid dispenser according to claim 1, in which the body (20) forms a top collar (208) under which the sleeve (32) comes into abutment in the final position.

8/ A fluid dispenser according to claim 3, in which the sleeve (32) has an inside wall that forms a holding bead (321) adapted to come into tight-fitting engagement with the intermediate segment (205) to hold the fixing member (3) in place on the body (20) when it is inserted into the neck.

9/ A fluid dispenser according to claim 1, in which the skirt (31) has an inside wall provided with a cam bead (311) serving to come into engagement with the cam segment (204).

10/ A fluid dispenser according to claim 1, in which the skirt (31; 31′) is provided with a bottom lip (316) in contact with the body (20).

11/ A fluid dispenser according to claim 9 or claim 10, in which the skirt (31; 31′) is in contact with the intermediate segment (205) via the cam bead (311) and via the bottom lip (316) only.

12/ A fluid dispenser according to claim 1, in which the fixing member (3) is provided with an abutment flange (33) serving to come freely into contact with the opening (10; 10′) without being force-fitted.

13/ A fluid dispenser according to claim 1, in which the body is provided with a vent hole (209) located at the level the skirt.
